(19) United States
(12) Patent Application Publication
(10) Pub. No.: US 2017/0364293 A1
(43) Pub. Date: Dec. 21, 2017

(54) METHOD AND APPARATUS FOR DATA PROCESSING

(71) Applicant: EMC IP Holding Company LLC, Hopkinton, MA (US)

(72) Inventors: Max Gang Huang, Beijing (CN); Yu Cao, Beijing (CN); Vivian Wenwen Gao, Beijing (CN); Dan Yuan, Westborough, MA (US); Grace Yan Cui, Beijing (CN)

(21) Appl. No.: 15/628,624

(22) Filed: Jun. 20, 2017

(30) Foreign Application Priority Data
Jun. 21, 2016 (CN) CN201610453751.8

(51) Int. Cl. G06F 3/06; G06F 17/30

(52) U.S. Cl. CPC G06F 3/0622; G06F 17/30569; G06F 3/0689

(57) ABSTRACT

Embodiments of the present disclosure relate to a method and apparatus for data processing. For example, a method is proposed, the method comprising: obtaining an intermediate identifier of data to be processed in an intermediate system; converting, based on an identifier mapping between the intermediate system and a remote system, the intermediate identifier into a first identifier in the remote system; and processing, in association with the remote system, the data at least partially based on the first identifier. A corresponding device and computer program product are also disclosed.

### RELATED APPLICATIONS

This application claim priority from Chinese Patent Application Number CN201610453751.8, filed on Jun. 21, 2016 at the State Intellectual Property Office. China, titled “DATA PROCESSING METHOD AND DEVICE” the contents of which is herein incorporated by reference in its entirety

### FIELD

Embodiments of the present invention generally relate to data processing, and more specifically, relate to a method and apparatus for data processing.

### BACKGROUND

Currently, there is an increasing demand on data storage. Widely used storage systems include, for example, file systems, block storage, and object storage. Compared with other storage systems (for example, the file systems that manage data as a file hierarchy and the block storage that manages data as blocks), the object storage is a storage architecture that manages data as objects.

The object storage, for example, is suitable for storing unstructured data and allows relatively inexpensive, scalable and self-healing retention of a massive amount of data. Solutions for public cloud object storage services have already been proposed. There have also been solutions intended to provide private cloud object storage services. These known solutions have some common features, for example, based on HTTP/HTTPS protocol, simple read/write application programming interface (API) in representational state transfer (REST) style, based on a specific API or the like. When a user uses the existing object storage services, the user will usually face problems such as low efficiency, low security and the like, which directly reduces user experience.

### SUMMARY

Embodiments of the present disclosure provide a method and apparatus for data processing and a corresponding computer program product.

According to a first aspect of the present disclosure, a method of data processing is proposed. The method comprises: obtaining an intermediate identifier of data to be processed in an intermediate system; converting, based on an identifier mapping between the intermediate system and a remote system, the intermediate identifier into a first identifier in the remote system; and processing, in association with the remote system, the data at least partially based on the first identifier.

In some embodiments, obtaining the intermediate identifier comprises: receiving, from a client, a user request for operating the data at the remote system; and extracting, from the user request, the intermediate identifier of the data.

In some embodiments, processing, in association with the remote system, the data comprises: generating, based on the user request, a first request for the operating at the remote system, the first request including the first identifier; and transmitting the first request to the remote system.

In some embodiments, the operating includes reading the data, and processing, in association with the remote system, the data further comprises: receiving the data from the remote system; and transmitting the data to the client.

In some embodiments, the remote system is a first remote system, and the operating includes updating the data at the first remote system, in which processing, in association with the remote system, the data further comprises: converting, based on an identifier mapping between the intermediate system and a second remote system, the intermediate identifier of the data into a second identifier of the data in the second remote system; generating a second request for updating the data at the second remote system, the second request including the second identifier; and transmitting the second request to the second remote system.

In some embodiments, the updating comprises at least one of: creating, deleting, and modifying.

In some embodiments, generating the first request comprises: generating the first request using a grammar different from that of the user request.

In some embodiments, at least one of the user request and the first request includes a key associated with the data.

In some embodiments, the remote system is a first remote system, and processing, in association with the remote system, the data comprises: converting, based on an identifier mapping between the intermediate system and a third remote system, the intermediate identifier into a third identifier of the data in the third remote system, the third remote system being different from the first remote system; obtaining the data from the third remote system using the third identifier; and storing the data into the first remote system using the first identifier.

In some embodiments, processing, in association with the remote system, the data comprises: deleting the data from the third remote system in response to at least one of: determining that the data has been completely stored in the first remote system, and all unprocessed requests for the data having been processed.

According to a second aspect of the present disclosure, an electronic device is proposed. The electronic device comprises: at least one processing unit; and at least one memory coupled to the at least one processing unit and storing machine-executable instructions which, when executed by the at least one processing unit, causes the at least one processing unit to be configured to: obtain an intermediate identifier of data to be processed in an intermediate system; convert, based on an identifier mapping between the intermediate system and a remote system, the intermediate identifier into a first identifier in the remote system; and process, in association with the remote system, the data at least partially based on the first identifier.

This Summary is provided to introduce a selection of concepts in a simplified form that are further described below in the Detailed Description. This Summary is not intended to identify key features or essential features of the present disclosure, nor is it intended to limit the scope of the present disclosure.

### BRIEF DESCRIPTION OF THE DRAWINGS

Through the following detailed description of example embodiments of the present disclosure with reference to the accompanying drawings, the above and other objectives, features, and advantages of the present disclosure will become more apparent. In the example embodiments of the present disclosure, like reference numerals usually indicate similar elements.

FIG. 1 shows a schematic diagram illustrating a storage system in a traditional solution;

FIG. 2 shows a schematic diagram illustrating a storage system according to an embodiment of the present disclosure;

FIG. 3 shows a schematic diagram illustrating an identifier mapping in an intermediate system according to an embodiment of the present disclosure;

FIG. 4 shows a schematic diagram of reading data by an intermediate system in association with a remote system according to an embodiment of the present disclosure;

FIG. 5 shows a schematic diagram of updating data by an intermediate system in association with a remote system according to an embodiment of the present disclosure;

FIG. 6 shows a schematic diagram of migrating data by an intermediate system in association with a remote system according to an embodiment of the present disclosure;

FIG. 7 shows a flow diagram of a process or method of data processing according to an embodiment of the present disclosure; and

FIG. 8 shows a schematic block diagram of an apparatus for data processing according to an embodiment of the present disclosure; and

FIG. 9 shows a schematic block diagram of a device suitable for implementing the embodiments of the present disclosure.

### DETAILED DESCRIPTION OF EMBODIMENTS

The preferred embodiments of the present disclosure will be described in more details below with reference to the accompanying drawings. Although the accompanying drawings show preferred embodiments of the present disclosure, it should be understood that the present disclosure may be implemented in various forms and should not be limited by the embodiments set forth herein. On the contrary, these embodiments are provided to make the present disclosure more thorough and complete and to convey the scope of the present disclosure to those skilled in the art.

As used herein, the term “includes” and its variants are to be read as open-ended terms that mean “includes, but is not limited to.” The term “or” is to be read as “and/or” unless the context clearly indicates otherwise. The term “based on” is to be read as “based at least in part on.” The term “one example embodiment” and “one embodiment” are to be read as “at least one example embodiment.” The term “another embodiment” is to be read as “at least another embodiment.” The terms “first”, “second” and the like may refer to different or same objects. Other explicit and implicit meanings may also be included hereinafter.

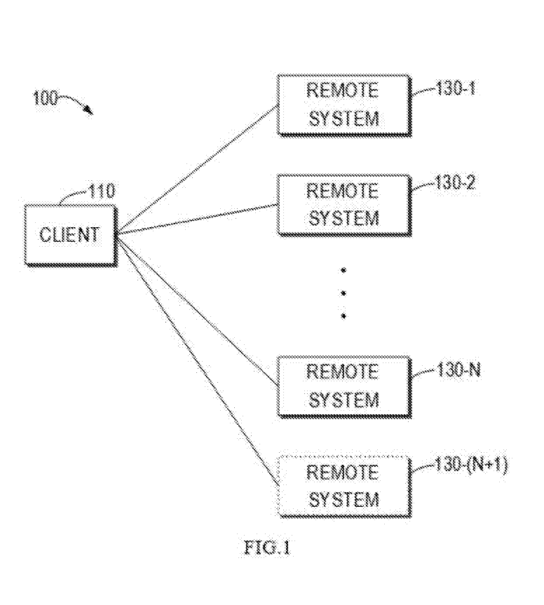

FIG. 1 shows a schematic diagram illustrating a storage system 100 in a traditional solution. The storage system 100 may comprise a client 110 and remote systems 130-1, . . . , 130-N, 130-(N+1) (collectively referred to as “remote systems 130”), where N is a natural number. The remote systems 130-1, . . . , 130-N, 130-(N+1) may store a massive amount of data to provide storage services for the client 110. The remote systems 130-1, . . . , 130-N, 130-(N+1) may provide an objective storage service, a file system storage service, a block storage service and the like. The type of the remote systems 130-1, . . . , 130-N, 130-(N+1) does not constitute a limitation to the embodiments of the present disclosure, as long as they can provide storage services. The client 110 may be a desktop computer, a laptop computer, a tablet computer, a smart phone, a personal digital assistant, a reader, an audio player, a camera or the like. The type of the client 110 does not constitute limitation to the embodiments of the present disclosure.

As illustrated in FIG. 1, the client 110 is connected to the remote systems 130-1, . . . , 130-N, and stores its data on the remote systems 130-1, . . . , 130-N. However, when the client 110 wants to migrate the data to another remote system such as the remote system 130-(N+1), it is hard for the client 110 to migrate the data stored on the remote systems 130-1, . . . , 130-N to the other remote system. Therefore, the client 110 has to face the risk of being locked to the remote systems 130-1, . . . , 130-N.

Additionally, in some cases, the client 110 expects that the data it stores on the remote systems 130-1, . . . , 130-N may flow between different remote systems as needed. However, because different remote systems have different configurations, in order to cause the data to flow between different remote systems, the remote systems usually has to be configured separately by the user, which makes it difficult to achieve data flowing.

In addition, before the user decides whether to store the data, a method for measuring different remote systems from a plurality of aspects such as cost, performance, and SLA (Service Level Agreement) is needed. For example, an enterprise user is highly demanding on the performance and SLA of the remote system, while is less demanding on cost control. Through the measurement, the enterprise user may select an optimal selection for a specific storage need of an enterprise application, for example. However, in the existing storage system 100, the user cannot measure a plurality of aspects of the remote systems 130-1, . . . , 130-N, such that an optimal selection cannot be made.

Therefore, when the user uses the existing storage system, the user will face a risk of being locked to a specific storage service, which makes it difficult to achieve data flowing between different remote systems and to measure the remote system to make an optimal selection. Consequently, the efficiency and security of the existing storage system cannot be guaranteed, which directly reduces user experience.

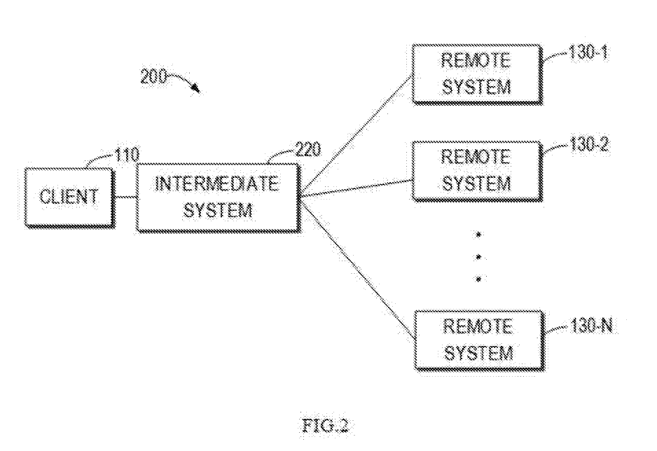

In order to solve the above and other potential problems and deficiencies, embodiments of the present disclosure provide a data processing solution. FIG. 2 shows a schematic diagram of a storage system 200 according to an embodiment of the present disclosure. Hereinafter, differences between the storage system 200 according to the embodiment of the present disclosure and the storage system 100 in the existing solution will be described in detail with reference to FIG. 1.

Particularly, in the discussion below, an example of using a data object as an object to be operated will mainly be described. However, it should be understood that this is only an example, and not intended to limit the scope of the present disclosure in any manner. In other embodiments, the data may be stored by any appropriate technique, regardless of whether the technique is currently known or future developed.

Similar to the storage system 100 as shown in FIG. 1, the storage system 200 as shown in FIG. 2 may comprise a client 110 and remote systems 130-1, . . . , 130-N. Different from the storage system 100 shown in FIG. 1, the storage system 200 shown in FIG. 2 may also comprise an intermediate system 220. As shown in FIG. 2, the client 110 is connected to the remote systems 130-1, . . . , 130-N via the intermediate system 220.

The intermediate system 220 may cause the client 110 to operate transparently the data on the remote systems 130-1, . . . , 130-N. Specifically, the intermediate system 220 may provide a set of interfaces compatible with the remote systems 130-1, . . . , 130-N, such that to the client 110, the intermediate system 220 behaves like the remote systems 130-1, . . . , 130-N. In addition, the intermediate system 220 may generate a universal intermediate identifier for the data (for example, each data object), the intermediate identifier being independent of the remote systems 130. Accordingly, the intermediate system 220 may maintain a mapping between the intermediate identifier of the data and remote identifiers of the data in the remote systems 130-1, . . . , 130-N, and the mapping is referred to as “an identifier mapping.” In some embodiments, the intermediate system 220 may also store metadata of the data. The metadata may be used for identifying the data and may include the intermediate identifier, the remote identifiers, and other information for describing the data. Moreover, the intermediate system 220 may measure a plurality of aspects of the remote systems 130-1 . . . , 130-N, such as cost, performance, and SLA, to facilitate the user to make an optimal selection.

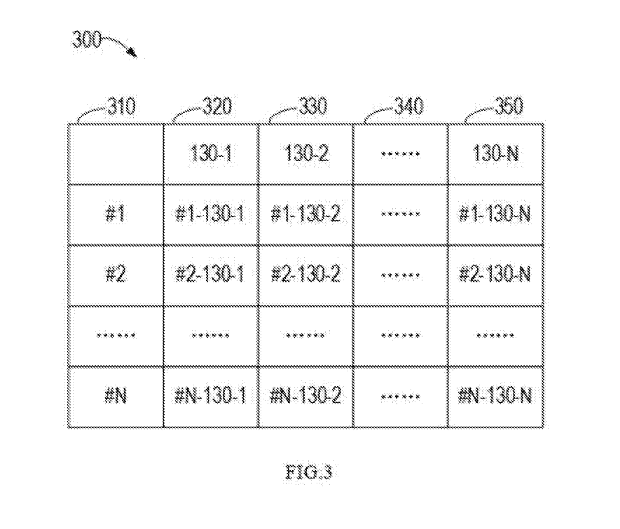

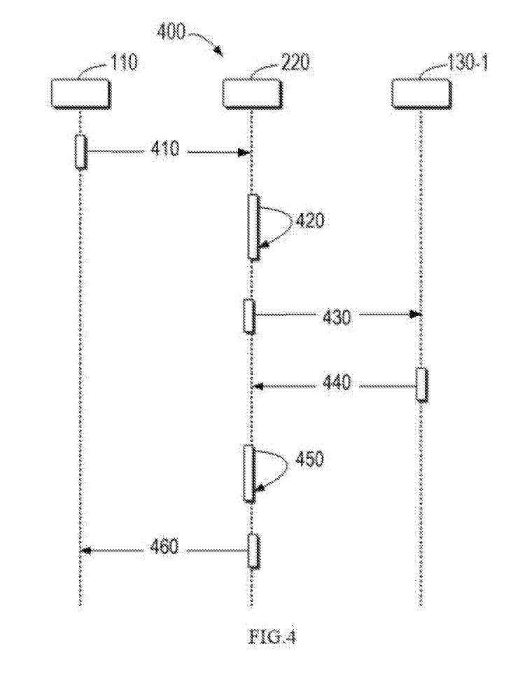

Hereinafter, several example operations/functions of the intermediate system 220 will be described with reference to FIGS. 4-6. FIG. 3 is firstly referred, which shows a schematic diagram illustrating the identifier mapping 300 in the intermediate system according to an embodiment of the present disclosure. As described above, the intermediate system 200 stores the identifier mapping between the intermediate identifier of the data in the intermediate system 200 and the identifiers of the data in the remote systems 130. In the example of FIG. 3, such identifier mapping is implemented by a mapping table 300. Of course, this is only an example. The identifier mapping may be stored in any appropriate data structure and/or format.

As illustrated in FIG. 3, the column 310 in the mapping table 300 represents the intermediate identifier of the data, while the other columns represent the remote identifiers corresponding to the intermediate identifier in the respective remote systems 130-1, . . . , 130-N. For example, the value recorded in the cell (2, 2) represents that the remote identifier of the data with the intermediate identifier #1 in the remote system 130-1 is #1-130-1. The intermediate system 220 may implement the conversion between the intermediate identifier and the remote identifier by querying the mapping table 300.

FIG. 4 shows a schematic diagram of a process 400 for reading the data by the intermediate system 220 in association with the remote system 130-1 according to an embodiment of the present disclosure. As shown in FIG. 4, the intermediate system 220 may receive (410), from the client 110, a user request for reading the data at the remote system 130-1. Suppose that the target data for the user request will be read from the first remote system 130-1.

In response to the request, the intermediate system 220 converts (420) the intermediate identifier of the data included in the user request in the intermediate system 220 into the identifier of the data in the target remote system (the first remote system 130-1 in this example), referred to as “a first identifier.” In some embodiments, the intermediate identifier is included in the user request. In such embodiments, the intermediate system 220 may extract the intermediate identifier from the user request, and converts the intermediate identifier into the first identifier based on the identifier mapping (for example, the mapping table 300 as shown in FIG. 3).

In some embodiments, in order to read the data stored in the first remote system 130-1, the user request may also include a key needed for accessing the first remote system 130-1. In such embodiments, the intermediate system 220 may also extract the key from the user request.

Next, the intermediate system 200 transmits (430) a request for reading the data to the first remote system 130-1 as the target, and the request is referred to as “a first request” The first request includes at least the first identifier. Additionally, as described above, in some embodiments, the intermediate system 220 may extract a key needed for accessing the data from the user request In such embodiments, the extracted key may also be included in the first request. Additionally, in some embodiments, the key needed for accessing the data may be stored in the intermediate system 220, and the intermediate system 220 may automatically include the key in the first request.

In particular, in some embodiments, the intermediate system 220 may perform the conversion of the format/grammar of the request, so as to adapt the characteristics and/or requirements of the destination remote systems. For example, the intermediate system 220 may generate the first request based on the requirements of the first remote system 130-1. The first request may have a grammar and/or format different from that of the original user request, but have a same meaning as that of the user request. In this way, the differences between the remote systems 130 are handled by the intermediate system 220, such that the differences are transparent to the client 110, which facilitates simplifying operations at the client.

After receiving the first request, the first system 130-1 will return the data to be read to the intermediate system 220. Accordingly, the intermediate system 220 receives (440) the data from the first remote system 130-1. In some embodiments, the received data may include its first identifier in the first remote system 130-1 for error checking and log processing or the like. Of course, this is not necessary. The received data may not include the first identifier, or may include other information for similar purposes to that of the first identifier. Then, the intermediate system 220 will provide (460) the data to the client 110.

As shown, in those embodiments where the received data include the first identifier, the intermediate system 220, for example, may convert (450) the first identifier of the data back to the intermediate identifier based on the identifier mapping 310. In such embodiments, when transmitting (460) the data to the client 110, the intermediate system 220 may include the intermediate identifier in the data. In this way, the client 110 may confirm that the obtained data are the requested data. Of course, this is not necessary. In other embodiments, the action 450 may be omitted.

The process 400 of reading the data by the client 110 from the first remote system 130-1 through the intermediate system 220 is described above. In some embodiments, when a plurality of duplicates of the data are stored in a plurality of remote systems, the intermediate system 220 may select any one of the duplicates in the plurality of remote systems, because the duplicates each have a same value. In some embodiments, the intermediate system 220 may measure a plurality of aspects of the plurality of remote systems, so as to select an optimal remote system. In one example, when the intermediate system 220 detects that one of the plurality of remote systems is unavailable, the intermediate system 220 may transmit the user request from the client 110 to other available remote systems, so as to improve availability of the storage system. In another example, the intermediate system 220 may measure network latency of the plurality of remote systems and transmit the user request from the client 110 to the remote system having the lowest latency, so as to improve performance of the storage system.

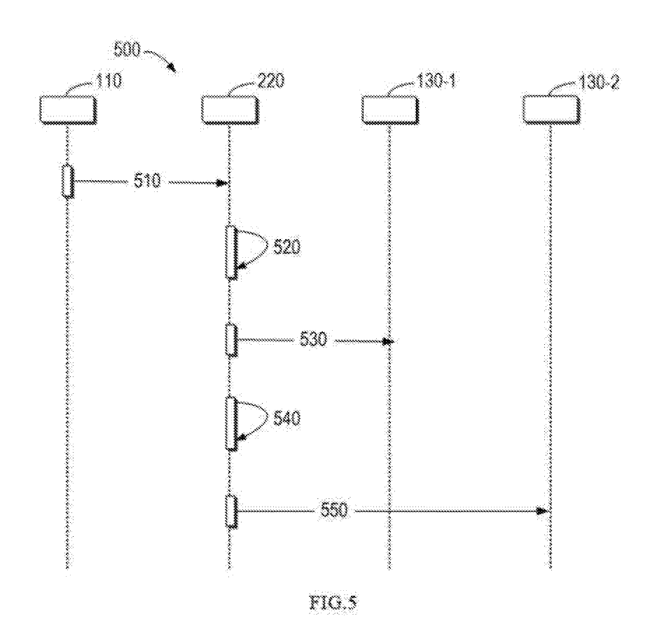

FIG. 5 is a schematic diagram of a process 500 of updating the data by the intermediate system 220 in association with the remote systems 130-1 and 130-2 according to an embodiment of the present disclosure. As shown in FIG. 5, the intermediate system 220 may receive (510), from the client 110, a user request for updating the data at the remote systems 130-1 and 130-2. Suppose that the target data for the user request will be updated at the first remote system 130-1 and the second remote system 130-2.

In response to the request, the intermediate system 220 converts (520) the intermediate identifier of the data included in the user request in the intermediate system 220 into an identifier of the data in the target remote system (the first remote system 130-1 in this example), referred to as “a first identifier.” In some embodiments, the intermediate identifier is included in the user request. In such embodiments, the intermediate system 220 may extract the intermediate identifier from the user request, and convert the intermediate identifier into the first identifier based on the identifier mapping (for example, the mapping table 300 as shown in FIG. 3).

In some embodiments, in order to update the data stored in the first remote system 130-1, the user request may also include a key needed for accessing the first remote system 130-1. In such embodiments, the intermediate system 220 may also extract the key from the user request.

Next, the intermediate system 200 transmits (530), to the first remote system 130-1 as a target, a request for updating the data, and the request is referred to as “a first request.” The first request includes at least the first identifier. In addition, as mentioned above, in some embodiments, the intermediate system 220 may extract a key needed for accessing the data from the user request. In such embodiments, the extracted key may be included in the first request. Additionally, in some embodiments, the key needed for accessing the data may be stored in the intermediate system 220, and the intermediate system 220 may automatically include the key in the first request.

Further, in response to the request, the intermediate system 220 converts (540) the intermediate identifier of the data included in the user request in the intermediate system 220 into an identifier of the data in the target remote system (the second remote system 130-2 in this example), referred to as “a second identifier.” In some embodiments, the intermediate identifier is included in the user request. In such embodiments, the intermediate system 220 may extract the intermediate identifier from the user request, and covert the intermediate identifier into the second identifier based on the identifier mapping (for example, the mapping table 300 as shown in FIG. 3).

In some embodiments, in order to update the data stored in the second remote system 130-2, the user request may also include the key needed for accessing the second remote system 130-2. In such embodiments, the intermediate system 220 may also extract the key from the user request.

Next, the intermediate system 200 transmits, to the second remote system 130-2 as a target, a request for updating the data, and the request is referred to as “a second request.” The second request includes at least the second identifier. In addition, as mentioned above, in some embodiments, the intermediate system 220 may extract a key needed for accessing the data from the user request. In such embodiments, the extracted key may also be included in the second request In addition, in some embodiments, the key needed for accessing the data may be stored in the intermediate system 220, and the intermediate system 220 may automatically include the key in the second request.

In particular, in some embodiments, the intermediate system 220 may perform the conversion of the format/grammar of the request, so as to adapt the characteristics and/or requirements of the target remote system. For example, the intermediate system 220 may generate a first request based on the requirements of the first remote system 130-1 and generate a second request based on the requirements of the second remote system 130-2. The first request and the second request may have a grammar and/or format different from that of the original user request, but have a same meaning as that of the user request. In this way, the differences between the remote systems 130 are handled by the intermediate system 220, such that the differences are transparent to the client 110, which facilitates simplifying operations at the client.

The process 500 for updating the data at the first remote system 130-1 and the second remote system 130-2 by the client 110 through the intermediate system 220 is described above. The updating may comprise one of creating, deleting, and modifying. In one example, when the client 110 creates the data through the intermediate system 220, the client 110 defines the data in the intermediate system 220 and configures a plurality of remote systems for the data. If the intermediate system 220 receives a user request for creating the data from the client 110 and identifies that the data is defined to have a plurality of duplicates in a plurality of remote systems, a plurality of user requests are transmitted to the plurality of remote systems, respectively, so as to create the data on the plurality of remote systems. In another example, when the client 110 modifies or deletes the data through the intermediate system 220, if the intermediate system 220 receives a user request for modifying or deleting the data from the client 110 and identifies that the data is stored in a plurality of remote systems, a plurality of user requests are transmitted to the plurality of remote systems, respectively, so as to modify or delete the data on the plurality of remote systems. The advantage of managing a plurality of duplicates of the data in the plurality of remote systems through the intermediate system 220 is that the user does not need to configure each remote system separately, which reduces the user workload and improves the efficiency. It may also improve the security of the storage system. For example, if a duplicate of the data in a certain remote system is damaged, duplicates of the data in other remote systems are still available.

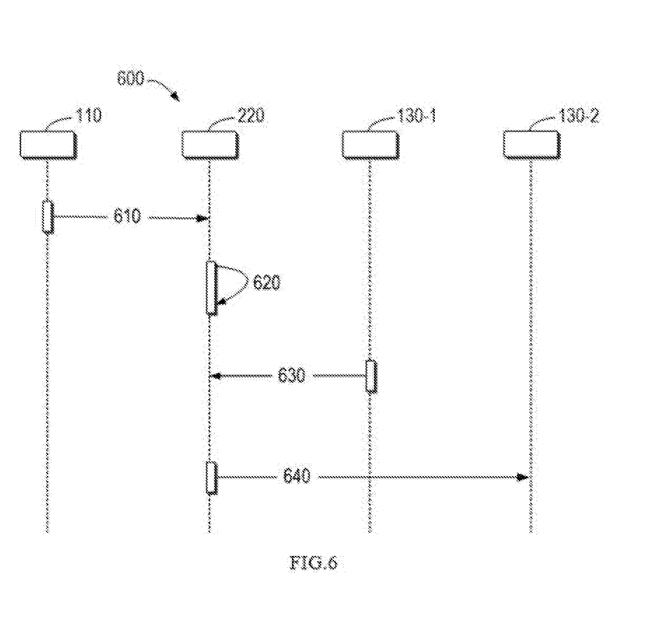

FIG. 6 is a schematic diagram of a process 600 of migrating the data by the intermediate system 220 in association with the remote systems 130-1 and 130-3 according to an embodiment of the present disclosure. As shown in FIG. 6, the intermediate system 220 may receive (610), from the client 110, a user request for migrating the data from the remote system 130-3 to the remote system 130-1. Suppose that the target data for the user request is migrated from the third remote system 130-3 to the first remote system 130-1.

In response to the request, the intermediate system 220 converts (620) the intermediate identifier of the data included in the user request in the intermediate system 220 into an identifier of the data in the target remote system (the first remote system 130-1 in this example), referred to as “first identifier.” Additionally, the intermediate system 220 converts the intermediate identifier of the data included in the user request in the intermediate system 220 into an identifier of the data in the target remote system (the third remote system 130-3 in this example), referred to as “a third identifier.” In some embodiments, the intermediate identifier is included in the user request. In such embodiments, the intermediate system 220 may extract the intermediate identifier from the user request and convert the intermediate identifier into the first identifier and the third identifier based on the identifier mapping (for example, the mapping table 300 as shown in FIG. 3).

In some embodiments, in order to migrate the data from the third remote system 130-3 to the first remote system 130-1, the user request may also comprise a key needed for accessing the first remote system 130-1 and the third remote system 130-3. In such embodiments, the intermediate system 220 may also extract the key from the user request. In addition, in some embodiments, the key needed for accessing the data may be stored in the intermediate system 220.

Next, the intermediate system 220 obtains (630) the data from the third remote system 130-3 using the third identifier, and stores (640) the data returned from the third remote system 130-3 to the first remote system 130-1 using the first identifier.

The process 600 of receiving, by the intermediate system 220, a user request for migrating the data from the client 110 is described above. During the migration of the data, the intermediate system 220 is a normal client from the perspective of the remote systems 130, and the intermediate system 22 may still obtain the data from the remote systems. Further, the intermediate system 220 may also transmit, to the first remote system 130-1, a new request for the data, after determining that the migrated data is completely stored in the first remote system 130-1. Furthermore, the intermediate system 220 may also transmit, to the third remote system 130-3, a request for deleting the data from the third remote system 130-3, after determining that the existing requests for the migrated data has been completely processed in the third remote system 130-3.

The client 110 may migrate the data between different remote systems as required by using the intermediate system 220, which improves availability and performance of data access, improves security of data protection, and eliminates risks of locking the client 110 to a specific remote system. As a result, the users will have a full control over their data.

Except for the implementation shown in FIG. 6, in some embodiments, the intermediate system 220 may automatically determine to migrate the data from one remote system to another remote system according to results of measuring a plurality of aspects of the plurality of remote systems 130. The migrating operation performed by the intermediate system 220 is transparent to the user, such that an optical selection may be automatically made for the user without increasing the user workload. In other words, in such embodiments, the migration of the data between the remote systems 130 is triggered by the intermediate system 220, rather than the request from the client 110.

In some other implementations, the intermediate system 220 may also receive a system request for migrating the data between the remote systems from one or more remote systems 130. For example, the intermediate system 220 may receive, from the remote system 130-3, a system request for migrating the data from the remote system 130-3 to the remote system 130-1. The intermediate system 220 may extract, from the system request, a third identifier of the data in the remote system 130-3. The intermediate system 220 may convert the third identifier into the intermediate identifier in the intermediate system 220 based on the identifier mapping, and further convert the intermediate identifier into the first identifier in the remote system 130-1. The intermediate system 220 obtains the data from the remote system 130-3 using the third identifier, and stores the data into the remote system 130-1 using the first identifier. Using the intermediate system 220 not only benefits the client, but also simplifies interoperations between the remote systems and improves flexibility of the entire storage system.

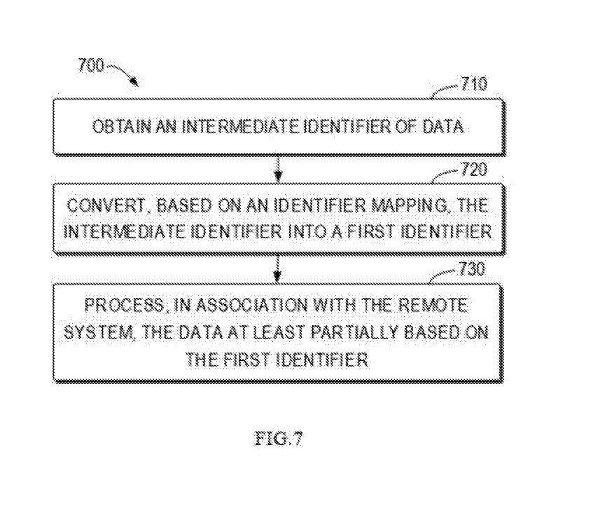

FIG. 7 is a flow diagram of a method 700 according to an embodiment of the present disclosure. In some embodiments, the method 700 may be implemented at the intermediate system 220. At 710, an intermediate identifier of data to be processed in the intermediate system is obtained. In some embodiments, at 710, a user request for operating the data at the remote system may be received from the client, and the intermediate identifier of the data may be extracted from the user request.

Next, at 720, the intermediate identifier is converted into a first identifier in the remote system based on the identifier mapping between the intermediate system and the remote system. The identifier mapping, for example, may be implemented by the mapping table 300 shown in FIG. 3 and/or any other appropriate structure.

At 730, the data is processed, in association with the remote system, at least partially based on the first identifier. In some embodiments, processing, in association with the remote system, the data comprises: generating, based on the user request, a first request for the operating at the remote system, the first request including the first identifier; and transmitting the first request to the remote system. In some embodiments, generating the first request comprises: generating the first request using a grammar different from that of the user request. In some embodiments, at least one of the user request and the first request includes a key associated with the data.

In some embodiments, the operating comprises reading the data. At this point, at 730, the data may be received from the remote system; and the data may be transmitted to the client.

For example, in some embodiments, the remote system is a first remote system, and the operating comprises updating the data at the first remote system. In some embodiments, updating, for example, may comprise at least one of: creating, deleting, and modifying. In such embodiments, at 730, the intermediate identifier of the data may be converted, based on an identifier mapping between the intermediate system and a second remote system, into a second identifier of the data in the second remote system; and a second request for updating the data at the second remote system may be generated, where the second request includes the second identifier; and the second request may be transmitted to the second remote system.

In some embodiments, the remote system is a first remote system. In such embodiments, at 730, the intermediate identifier may be converted, based on an identifier mapping between the intermediate system and a third remote system, into a third identifier of the data in the third remote system, the third remote system may be different from the first remote system; the data may be obtained from the third remote system using the third identifier data, and the data may be stored into the first remote system using the first identifier

In some embodiments, at 730, the data may be deleted from the third remote system in response to at least one of: determining that the data has been completely stored in the first remote system, and all unprocessed requests for the data having been processed.

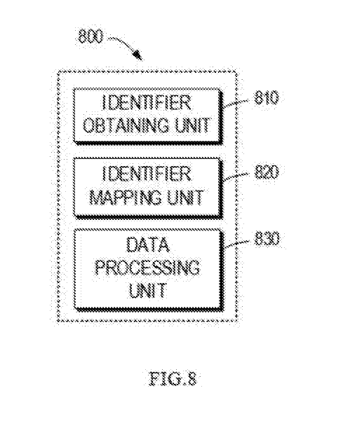

FIG. 8 is a schematic block diagram of an apparatus 800 for data processing according to an embodiment of the present disclosure. The apparatus 800, for example, may be implemented at the intermediate system 220 or directly acts as the intermediate system 220. As shown, the apparatus 800 comprises an identifier obtaining unit 810, an identifier mapping unit 820, and a data processing unit 830.

The identifier obtaining unit 810 is configured to extract an intermediate identifier of data to be processed from a user request received by a client.

The identifier mapping unit 820 is configured to convert, based on an identifier mapping between the intermediate system and a remote system, the intermediate identifier into a first identifier in the remote system. The data processing unit 830 is configured to process, in association with the remote system, the data at least partially based on the first identifier.

In some embodiments, the identifier obtaining unit 810 is configured to receive, from the client, a user request for operating the data at the remote system; and extract the intermediate identifier of the data from the user request.

In some embodiments, the data processing unit 830 is configured to generate, based on the user request, a first request for the operating at the remote system, where the first request includes the first identifier; and transmit the first request to the remote system. For example, in some embodiments, the data processing unit 830 is configured to generate the first request using a grammar different from that of the user request. Alternatively or additionally, in some embodiments, at least one of the user request and the first request includes a key associated with the data.

In some embodiments, the operating includes reading the data. In such embodiments, the data processing unit 830 is configured to receive the data from the remote system; and transmit the data to the client.

In some embodiments, the remote system is a first remote system, and the operating includes updating the data at the first remote system. In such embodiments, the data processing unit 830 is configured to: convert, based on an identifier mapping between the intermediate system and a second remote system, the intermediate identifier of the data into a second identifier of the data at the second remote system; generate a second request for updating the data at the second remote system, where the second request includes the second identifier; and transmit the second request to the second remote system.

In some embodiments, the remote system is a first remote system. In such embodiments, the data processing unit 830 is configured to convert, based on an identifier mapping between the intermediate system and a third remote system, the intermediate identifier into a third identifier of the data in the third remote system, where the third remote system is different from the first remote system; obtain the data from the third remote system using the third identifier; and store the data into the first remote system using the first identifier.

In some embodiments, the data processing unit 830 is also configured to delete the data from the third remote system in response to at least one of: determining that the data have been completely stored in the first remote system, and all unprocessed requests for the data having been processed.

The units included in the apparatus 800 may be implemented in various ways, including software, hardware, firmware or any combination thereof. In one embodiment, one or more units may be implemented using software and/or firmware, for example, machine-executable instructions stored on a storage medium. In addition to the machine-executable instructions or as an alternative thereto, part or all of the units in the apparatus 800 may be at least partially implemented by one or more hardware logic components. By way of an example, and not limitation, the example types of hardware logic components that can be used comprise programmable field gate array (FPGA), application specific integrated circuit (ASIC), application specific standard product (ASSP), system on chip (SOC), complex programmable logic device (CPLD) and so on.

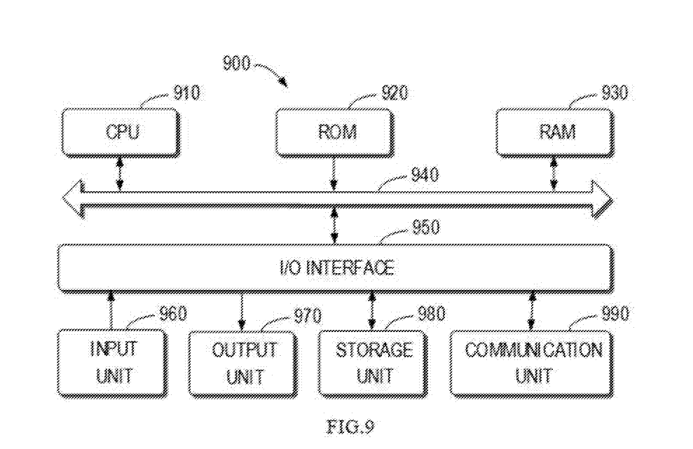

FIG. 9 is a schematic block diagram of an electronic device 900 suitable for implementing embodiments of the present disclosure. As shown, the device 900 comprises a central processing unit (CPU) 910 that may execute various appropriate actions and processing according to computer program instructions stored in a read-only memory (ROM) 920 or computer program instructions loaded onto a random access memory (RAM) 930 from a storage unit 980. In the RAM 930, various programs and data needed for operation of the device 900 may also be stored. The CPU 910, ROM 920, and RAM 930 are connected with each other via a bus 940. The input/output (I/O) interface 950 is also connected to the bus 940.

A plurality of components in the device 900 are connected to the I/O interface 950, comprising: an input unit 960, such as a keyboard, a mouse or the like; an output unit 970, such as various types of displays, loudspeakers or the like; a storage unit 980, such as a magnetic disk, an optical disk or the like; and a communication unit 990, such as a network card, a modem, a radio communication transceiver or the like. The communication unit 990 allows the device 900 to exchange information/data with other device through a computer network such as Internet and/or various kinds of telecommunication networks.

Various processes and processing described above, for example, processes/methods 400, 500, 600, and 700, may be executed by the processing unit 910. For example, in some embodiments, the processes/methods 400, 500, 600, and 700 may be implemented as computer software programs that are tangibly embodied in the machine-readable medium, for example, the storage unit 980. In some embodiments, part or all of the computer programs may be loaded and/or installed onto the device 900 via the ROM 920 and/or communication unit 990. When the computer program is loaded onto the RAM 930 and executed by the CPU 910, one or more acts of methods 400, 500, 600, and 700 described above may be carried out. Alternatively, in other embodiments, the CPU 901 may also be configured to implement the processes/methods described above in any other appropriate manner.

Through the teachings offered by the above description and relevant drawings, many modifications and other implementations of the present disclosure given herein will be appreciated by those skilled in the art. Therefore, it is understood that the embodiments of the present disclosure are not limited to the specific implementations disclosed herein, and the modifications and other implementations are intended to be included within the scope of the present disclosure. Additionally, although the above description and relevant drawings describe the example implementations in the context of some example combinations of components and/or functions, it should be noted that different combinations of components and/or functions may be provided by alternative implementations without departing from the scope of the present disclosure. At this point, for example, other combinations of components and/or functions different from what has been explicitly described above are also anticipated to fall within the scope of the present disclosure. Although specific terms are used herein, they are only used in general and descriptive meanings, but not intended to be limiting.

I/We claim:

1. A method of data processing, comprising:
obtaining an intermediate identifier of data to be processed in an intermediate system;
converting, based on an identifier mapping between the intermediate system and a remote system, the intermediate identifier into a first identifier in the remote system; and
processing, in association with the remote system, the data at least partially based on the first identifier.

2. The method according to claim 1, wherein obtaining the intermediate identifier comprises:
receiving, from a client, a user request for operating the data at the remote system; and
extracting, from the user request, the intermediate identifier of the data.

3. The method according to claim 2, wherein processing, in association with the remote system, the data comprises:
generating, based on the user request, a first request for the operating at the remote system, the first request including the first identifier; and
transmitting the first request to the remote system.

4. The method according to claim 3, wherein the operating includes reading the data, and processing, in association with the remote system, the data further comprises:
receiving the data from the remote system; and
transmitting the data to the client.

5. The method according to claim 3, wherein the remote system is a first remote system, and the operating includes updating the data at the first remote system, wherein processing, in association with the remote system, the data further comprises:
converting, based on an identifier mapping between the intermediate system and a second remote system, the intermediate identifier of the data into a second identifier of the data in the second remote system;
generating a second request for updating the data at the second remote system, the second request including the second identifier; and
transmitting the second request to the second remote system.

6. The method according to claim 5, wherein the updating comprises at least one of: creating, deleting, and modifying.

7. The method according to claim 3, wherein generating the first request comprises:
generating the first request using a grammar different from that of the user request.

8. The method according to claim 3, wherein at least one of the user request and the first request includes a key associated with the data.

9. The method according to claim 1, wherein the remote system is a first remote system, and processing, in association with the remote system, the data comprises:
converting, based on an identifier mapping between the intermediate system and a third remote system, the intermediate identifier into a third identifier of the data in the third remote system, the third remote system being different from the first remote system;
obtaining the data from the third remote system using the third identifier, and
storing the data into the first remote system using the first identifier.

10. The method according to claim 9, further comprising:
deleting the data from the third remote system in response to at least one of:
determining that the data has been completely stored in the first remote system, and
all unprocessed requests for the data having been processed.

11. An electronic device, comprising:
at least one processing unit; and
at least one memory coupled to the at least one processing unit and storing machine-executable instructions which, when executed by the at least one processing unit, cause the at least one processing unit to be configured to:
obtain an intermediate identifier of data to be processed in an intermediate system;
convert, based on an identifier mapping between the intermediate system and a remote system, the intermediate identifier into a first identifier in the remote system; and
process, in association with the remote system, the data at least partially based on the first identifier

12. The device according to claim 11, wherein the at least one processing unit is configured to:
receive, from a client, a user request for operating the data at the remote system; and
extract, from the user request, the intermediate identifier of the data.

13. The device according to claim 12, wherein the at least one processing unit is configured to:
generate, based on the user request, a first request for the operating at the remote system, the first request including the first identifier, and
transmit the first request to the remote system.

14. The device according to claim 13, wherein the operating includes reading the data, and the at least one processing unit is configured to:
receive the data from the remote system; and
transmit the data to the client.

15. The device according to claim 13, wherein the remote system is a first remote system, and the operating includes updating the data at the first remote system, wherein the at least one processing unit is configured to:
convert, based on an identifier mapping between the intermediate system and a second remote system, the intermediate identifier of the data into a second identifier of the data in the second remote system;
generate a second request for updating the data at the second remote system, the second request including the second identifier; and
transmit the second request to the second remote system.

16. The device according to claim 15, wherein the updating comprises at least one of: creating, deleting, and modifying.

17. The device according to claim 13, wherein the at least one processing unit is configured to:
generate the first request using a grammar different from that of the user request.

18. The device according to claim 13, wherein at least one of the user request and the first request includes a key associated with the data.

19. The device according to claim 11, wherein the remote system is a first remote system, and the at least one processing unit is configured to:
convert, based on an identifier mapping between the intermediate system and a third remote system, the intermediate identifier into a third identifier of the data in the third remote system, the third remote system being different from the first remote system;
obtain the data from the third remote system using the third identifier; and
store the data into the first remote system using the first identifier.

20. A computer program product for data processing, the computer program product comprising:
a non-transitory computer readable medium encoded with computer-executable code, the code configured to enable the execution of:
obtaining an intermediate identifier of data to be processed in an intermediate system;
converting, based on an identifier mapping between the intermediate system and a remote system, the intermediate identifier into a first identifier in the remote system; and
processing, in association with the remote system, the data at least partially based on the first identifier.
